(19) United States
(12) Patent Application Publication
(10) Pub. No.: US 2019/0256164 A1
(43) Pub. Date: Aug. 22, 2019

(54) SELF-BALANCING SCOOTER

(71) Applicant: Zheijiang Raymond Way Electronic Technology Co., LTD., Wuyi City (CN)

(72) Inventors: ZHIJUN YANG, Shenzhen City (CN); JUNJIE WANG, Yongkang City (CN); FEI CHENG, Yongkang City (CN)

(21) Appl. No.: 16/404,737

(22) Filed: May 6, 2019

Related U.S. Application Data
(63) Continuation of application No. PCT/CN2016/110439, filed on Dec. 16, 2016.

(51) Int. Cl. B62K 11/00; B62J 99/00; B62J 9/00

(52) U.S. Cl. CPC B62K 11/007; B62J 99/00; B62J 9/00; B62K 2204/00; B62K 2207/00; B62J 2099/0033; B62K 2202/00; B62J 2099/002

(57) ABSTRACT

A self-balancing scooter includes a scooter body including an integrated main framework with two opposite ends and wheels mounted to the two ends of the main framework respectively, a driving mechanism mounted on the main framework, a foot pedal mounted on the driving mechanism, and a connecting shaft with a first end and a second end opposite to the first end. The first end of the connecting shaft is fixedly connected to the main framework, and the second end of the connecting shaft is connected to the driving mechanism such that the driving mechanism and the foot pedal are pivotable relative to the main framework. The driving mechanism drives the wheels to rotate. The disclosure increases the load carrying capacity of the self-balancing scooter, avoids too tight or too loose connection between the connecting shaft and the main frameworks, and prolongs the service life of the self-balancing scooter.

### CROSS REFERENCE TO RELATED APPLICATIONS

This non-provisional patent application is a continuation application of an international application No. PCT/CN2016/110439 filed on Dec. 16, 2016. The applications are incorporated herein by reference.

### TECHNICAL FIELD

The present invention relates to the field of vehicles, and in particular to a self-balancing scooter.

### BACKGROUND

A traditional self-balancing scooter includes a left main framework and a right main framework, and the left main framework and the right main framework are connected by a connecting shaft. Steering the self-balancing scooter can be acquired by controlling relative angles of the left main framework and the right main framework. However, for the traditional balancing scooter, it is difficult to control connection precision of the connecting shaft, thereby easily causing the connecting shaft to be too tight or too loose or broken, and a great potential risk exists.

### SUMMARY

In order to overcome the deficiencies of the prior art, the disclosure provides a self-balancing scooter.

The objective of the disclosure is achieved by the following technical solutions:

A self-balancing scooter includes a scooter body including an integrated main framework with two opposite ends and wheels mounted to the two ends of the main framework respectively, a driving mechanism mounted on the main framework, a foot pedal mounted on the driving mechanism, and a connecting shaft with a first end and a second end opposite to the first end; where the first end of the connecting shaft is fixedly connected to the main framework, and the second end of the connecting shaft is connected to the driving mechanism such that the driving mechanism and the foot pedal are pivotable relative to the main framework; the driving mechanism drives the wheels to rotate.

In the disclosure, the main framework is integrally formed as one single unit, and the wheel is directly fixed on the main framework, thereby increasing the load carrying capacity of the self-balancing scooter, avoiding too tight or too loose connection between the connecting shaft and the main frameworks or the connecting shaft broken in that two main frameworks of the two wheels are connected through the connecting shaft in the prior art, and prolonging the service life of the self-balancing scooter.

Preferably, the self-balancing scooter further includes another driving mechanism, wherein each of the driving mechanisms is connected to the main framework through two connecting shafts.

Preferably, the self-balancing scooter further includes a bearing member, a number of the bearing member is corresponding to a number of the connecting shaft, and the connecting shaft is connected to the main framework through the bearing member.

Preferably, the connecting shaft is configured with a first through hole, the driving mechanism is configured with a screw hole, and a position of the screw hole is corresponding to a position of the first through hole.

Preferably, the self-balancing scooter further includes an elastic member connected between the driving mechanism and the main framework.

Preferably, the elastic member includes a coil spring and a spring cap mounted to the driving mechanism, the coil spring includes a first end and a second end, the first end of the coil spring is mounted to the main framework, and the second end of the coil spring is connected to the spring cap.

Preferably, the foot pedal includes a left foot pedal and a right foot pedal, and the left foot pedal is mounted on the driving mechanism and the right foot pedal is mounted on the another driving mechanism.

Preferably, the scooter body is configured with a battery and a control panel, and the battery and the control panel are both electrically connected to the driving mechanism.

Preferably, the drive mechanism includes a gyroscope and a gyroscope mounting plate, and the gyroscope is mounted to the gyroscope mounting plate and connected to the control panel.

Preferably, the scooter body further includes a motor clamp, and the wheel includes a motor body and a first rotating shaft extending from the motor body, and the first rotating shaft is connected to the main framework through the motor clamp.

Preferably, the self-balancing scooter further includes an infrared sensor switch, and the infrared sensor switch is mounted to the foot pedal.

Preferably, the infrared sensor switch includes a first infrared sensor switch mounted to the left foot pedal and a second infrared sensor mounted to the right foot pedal.

Preferably, the infrared sensor switch includes an infrared emitter and an infrared receiver; the infrared emitter of the first infrared sensor switch is mounted at a side of the left foot pedal, and the infrared receiver of the first infrared sensor switch is mounted at an opposite side of the left foot pedal and facing the infrared emitter of the first infrared sensor switch; the infrared emitter of the second infrared sensor switch is mounted at a side of the right foot pedal, and the infrared receiver of the second infrared sensor switch is mounted at an opposite side of the right foot pedal and facing the infrared emitter of the second infrared sensor switch.

Preferably, the self-balancing scooter further includes a storage box, an upper cover, a rotating shaft, and a storage box cover; the upper cover is rotationally mounted on the storage box via the rotating shaft, and the storage box cover is mounted on the upper cover.

Preferably, the self-balancing scooter further includes a liquid crystal display, and the liquid crystal display is mounted to the storage box cover.

Preferably, the self-balancing scooter further includes a storage box switch mounted on the upper cover and configured to open or close the storage box cover.

Preferably, the self-balancing scooter further includes a bearing member and a bearing fixing member; the first end of the connecting shaft is mounted in the bearing member, and the bearing member is mounted on the main framework through the bearing fixing member.

### BRIEF DESCRIPTION OF THE DRAWINGS

FIG. 1 is a schematic structural view of a self-balancing scooter according to an embodiment of the disclosure;

FIG. 2 is an exploded perspective view of the self-balancing scooter of the disclosure;

FIG. 3 is a schematic cross-sectional view of the self-balancing scooter of the disclosure;

FIG. 4 is an exploded perspective view of a scooter body of the disclosure;

FIG. 5 is an exploded perspective view of a main framework including a connecting shaft of the disclosure;

FIG. 6 is a schematic structural view of the main framework of the disclosure;

FIG. 7 is an exploded perspective view of a driving mechanism of the disclosure;

FIG. 8 is a schematic structural view of a gyroscope mounting plate of the disclosure;

FIG. 9 is an exploded perspective view of an elastic member of the disclosure;

FIG. 10 is an exploded perspective view of a foot pedal of the disclosure.

### DETAILED DESCRIPTION OF THE PREFERRED EMBODIMENTS

Below, embodiments of the disclosure will be described in detail with reference to the drawings. It should be noted that the figures are illustrative rather than limiting. The figures are not drawn to scale, only for illustrating every aspect of the described embodiments, and do not limit the scope of the present disclosure.

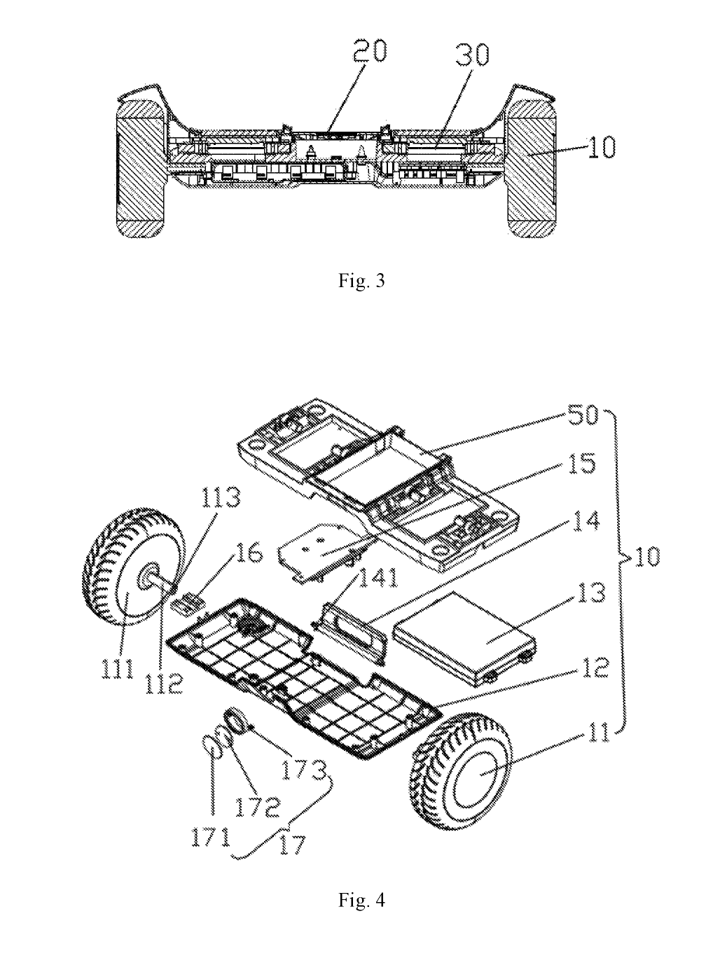

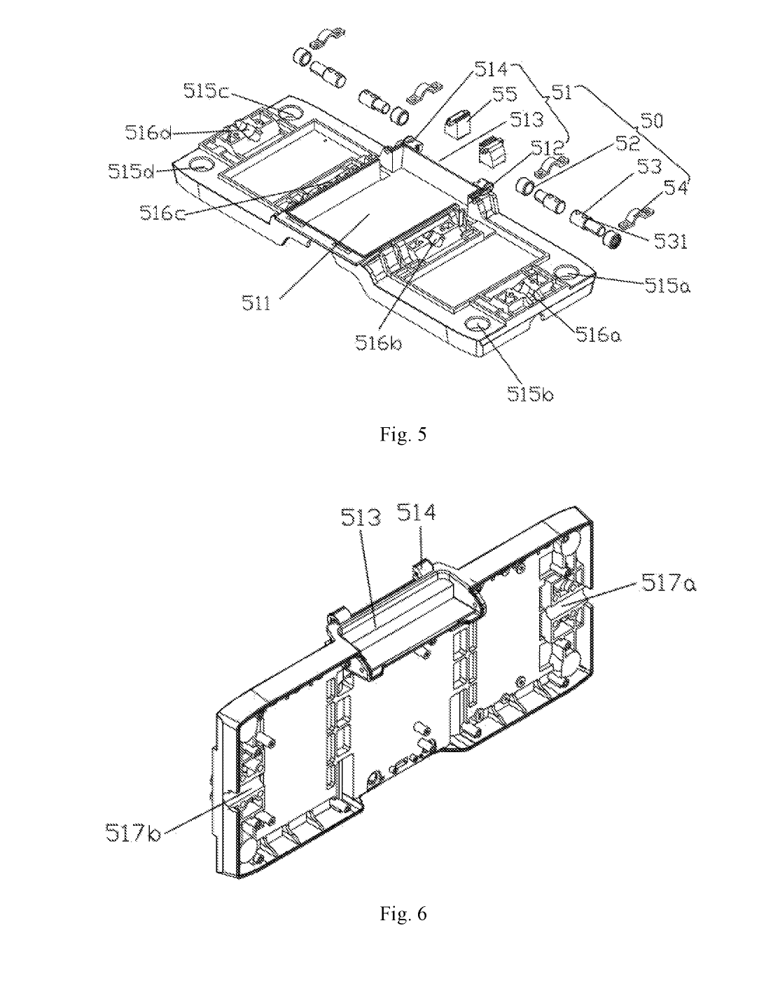

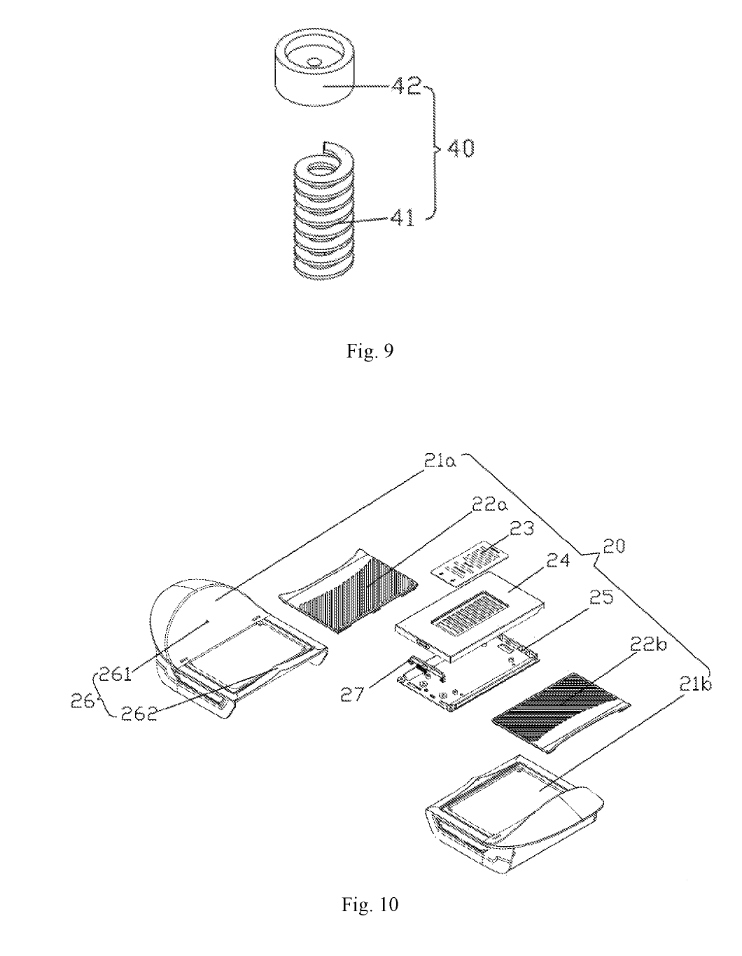

As shown in FIGS. 1-10, an embodiment of the disclosure provides a self-balancing scooter including a scooter body 10, a foot pedal 20, and a driving mechanism 30. The scooter body 10 includes an integrated main framework 50 and wheels 11 mounted to two ends of the main framework 50, the main framework 50 is configured with a connecting shaft 53, and the driving mechanism 30 is rotationally connected to the main framework 50 via the connecting shaft 53. The foot pedal 20 is mounted on the driving mechanism 30.

When the user's legs stand on the foot pedal 20, the driving mechanism 30 is in a balance state, and the wheels 11 remain stationary. Due to the driving mechanism 30 is rotationally connected to the main framework 50 through the connecting shaft 53, when the user adjusts his or her posture, the driving mechanism 30 adjusts the wheels 11 on two ends of the main framework 50 according to the user's posture to control the self-balancing scooter to move forward, move backward, or make a turn.

In the embodiment of the present invention, the main framework 50 is integrally formed as one single unit, and the wheels 11 are directly fixed on the main framework 50, thereby increasing the load carrying capacity of the self-balancing scooter, avoiding too tight or too loose connection between the connecting shaft and the main frameworks or the connecting shaft broken in that two main frameworks of the two wheels are connected through the connecting shaft in the prior art, and prolonging the service life of the self-balancing scooter.

As shown in FIGS. 4-6, the scooter body 10 further includes two motor clamps 16, and the wheel 11 includes a motor body 111 and a first rotating shaft 112 extending from the motor body 111. In this embodiment, the first rotating shaft 112 includes a first side surface, a second side surface, and an end surface. The first side surface is an arc surface, and the second side surface is a flat surface. The main framework 50 is configured with two first mounting seats 517a, 517b. The two first rotating shafts 112 of the two wheels 11 are respectively fixed to the two first mounting seats 517a, 517b by the motor clamp 16, the first side surface is adjacent to the first seat 517a, 517b, and the second surface is adjacent to the motor clamp 16. In the embodiment, the relative sliding between the first rotating shaft 112 and the main framework 50 in the circumferential direction the first rotating shaft 112 is avoided, and the main framework 50 may be supplied with great torque to drive the self-balancing scooter to move forward.

As shown in FIGS. 4-6, a second through hole 113 is formed in the end surface of the first rotating shaft 112 for receiving a power cable. The motor body 111 is supplied power through the cable received in the second through hole 113 to drive the wheel 11 to rotate.

As shown in FIGS. 4-6, the scooter body 10 is configured with a battery 13 and a control panel 15, a lower cover 12 is disposed below the main framework 50, and the battery 13 and the control panel 15 are both mounted in a cavity formed by the main framework 50 and the lower cover 12. Thus, the battery 13 and the control panel 15 may be well protected from external damage. In this embodiment, the battery 13, the control panel 15, the motor body 111, and the driving mechanism 30 are electrically connected in sequence. The drive mechanism 30 drives the motor body 111 to rotate through the control panel 15 to control the self-balancing scooter to move forward, move backward, or make a turn.

As shown in FIGS. 4-6, the scooter body 10 further includes an illuminant 17 including a lamp board 171, a lamp body 172 and a lamp holder 173. A lamp socket (not shown) corresponding to the lamp holder 173 is disposed to a joint of the lower cover 12 and the main framework 50, the lamp body 172 is mounted between the lamp board 171 and the lamp holder 173, the lamp holder 173 is fixed to the lamp socket, and the lamp body 172 is electrically connected to the control panel 15. In the embodiment, the lamp board 171 is further configured with a logo to facilitate product promotion and improve market competitiveness. The self-balancing scooter of the disclosure not only increases the user's pleasure to use, but also reminds the user the current state of the self-balancing scooter.

As shown in FIGS. 4-6, in the embodiment, the self-balancing scooter includes a handlebar 14. The handlebar 14 is configured with a second rotating shaft 141, the main framework 50 is configured with a handle cavity 513, and the handlebar 14 is mounted in the handle cavity 513 through the second rotating shaft 141. In the embodiment, the second rotating shaft 141 is configured with a return spring (not shown). When the self-balancing scooter is carried by the user, the handlebar 14 may be pulled out from the handle cavity 513, so that it may be easily taken by the hand of the user. When the self-balancing scooter does not need to be carried or used, the handlebar 14 is released by the hand and returned back to the handle cavity 513 through the return spring.

As shown in FIGS. 4-8, the self-balancing scooter includes a bearing member 52 and a bearing fixing member 54. In the embodiment, the bearing member 52 is preferably a cylindrical roller bearing, which improves the bearing capacity of the foot pedal 20. The number of the driving mechanism 30 is two, and the number of the connecting shaft 53, the bearing member 52 and the bearing fixing member 54 are respectively four. The main framework 50 is configured with second mounting seats 516a, 516b, 516c, 516d, and two ends of the drive mechanism 30 are respectively configured with a connecting shaft fixing end 61a, 61b, and each bearing member 52 is respectively mounted on the bearing mounting seat 516a, 516b, 516c, 516d through the bearing fixing member 54. A first end of the connecting shaft 53 is connected with the bearing member 52, and a second end of the connecting shaft 53 is mounted to the driving mechanism 30, and two connecting shafts 53 are respectively fixed to the connecting shaft fixing ends 61a, 61b of one driving mechanism 30. In the embodiment, the weight on the drive mechanism 30 is distributed to each of the connecting shafts 53, thereby prolonging the service life of the product. And the relative flexibility of the drive mechanism 30 and the main framework 50 is ensured, thereby improving the control precision of the product.

As shown in FIGS. 4-8, the connecting shaft 53 is configured with a first through hole 531, and the driving mechanism 30 is configured with a screw hole 64. A position of the screw hole 64 is corresponding to a position of the first through hole 531, and a screw (not shown) is capable of passing through the first through hole 531 to be connected to the screw hole 64, and thus it is convenient to disassemble, replace, and repair the connecting shaft 53, thereby reducing the maintenance cost of the product.

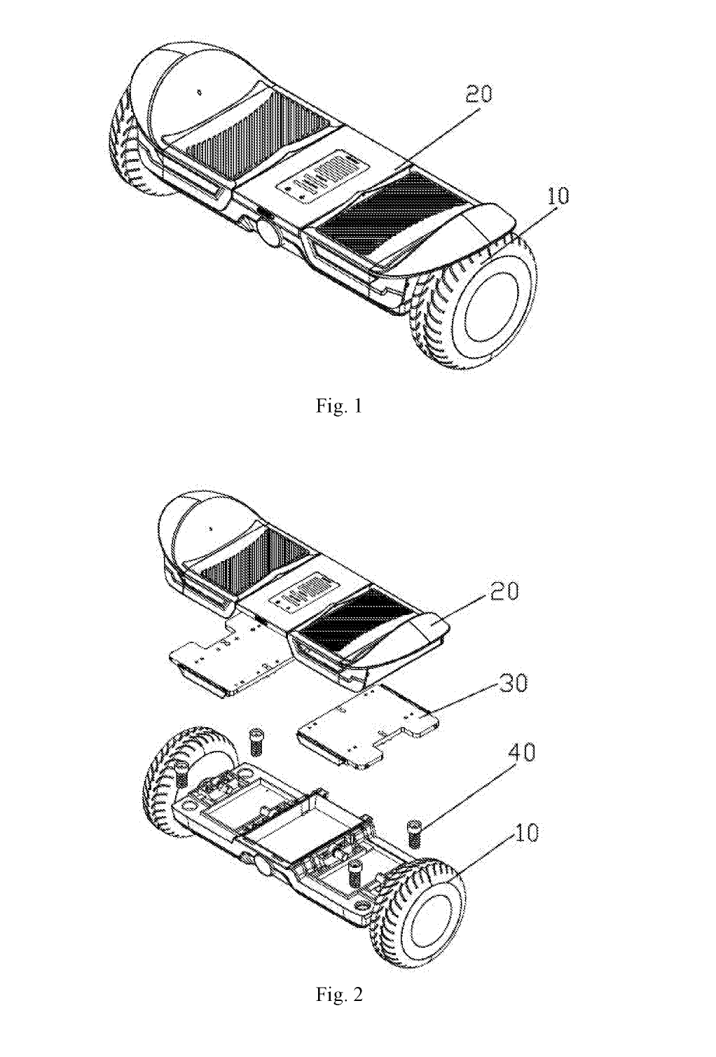

As shown in FIGS. 2-9, the main framework 50 is configured with four first holes 515a, 515b, 515c, 515d, and the driving mechanism 30 is configured with two second holes 62a, 62b. The scooter body 10 further includes an elastic member 40, and the elastic member 40 may be any elastomers. In the embodiment, the scooter includes four elastic members 40, and each elastic member 40 includes a coil spring 41 and a spring cap 42, and the coil spring 41 includes a first end and a second end. The first ends of the four coil springs 41 are respectively mounted in the first holes 515a, 515b, 515c, 515d, and the second ends of the four coil springs 41 are respectively connected to the four spring caps 42, and each two spring caps 42 is respectively mounted in the second holes 62a, 62b of the one drive mechanism 30. After adopting the above technical solution, the carrying capacity of the self-balancing scooter is further improved, and the self-balancing scooter may be in a permanent balance state when the scooter is stationary.

As shown in FIGS. 4-8, the main framework 50 is configured with a storage box 511, and each of two sides of one end of the storage box 511 is configured with a slotted plug 55. The foot pedal 20 includes a left foot pedal 21a, a right foot pedal 21b, and an upper cover 25, and a storage box cover 24 and a storage box switch 27 are mounted on the upper cover 25. The main framework 50 is configured with a third rotating shaft 514, and the upper cover 25 is rotationally mounted on the storage box 511 via the third rotating shaft 514. When storing the item, the user may open the upper cover 25 through the storage box switch 27 and place the item in the storage box 511, after that, the user closes the upper cover 25. In the embodiment, the slotted plug 55 is made of silicone rubber. Thus, the slotted plug 55 is not only easy to be installed, but also used as a cushioning when the storage box cover 24 is closed.

As shown in FIGS. 4-8, the main framework 50 is made of a magnesium alloy, which not only improves the bearing capacity of the main framework 50, but also ensures the overall weight of the self-balancing scooter not too much and avoids energy loss and inconvenient carrying due to excessive weight.

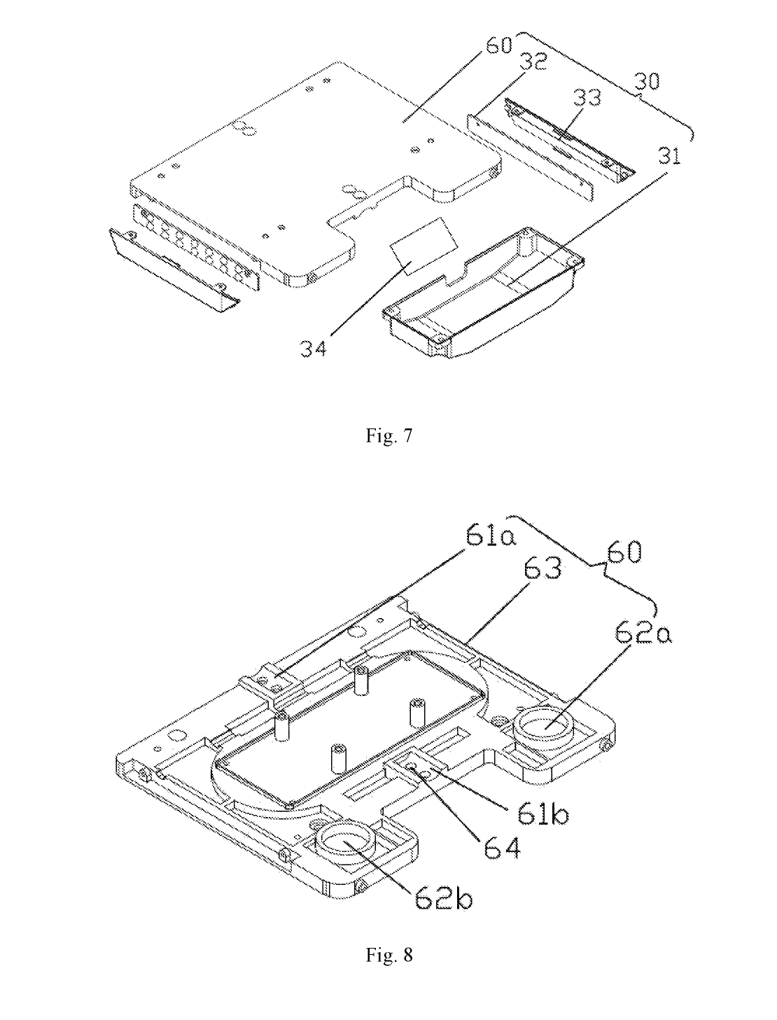

As shown in FIGS. 7-8, the drive mechanism 30 includes a gyroscope 34, a gyroscope mounting plate 60, and a gyroscope mounting cover 31. The gyroscope 34 is mounted to the gyroscope mounting plate 60, and the gyroscope mounting cover 31 is mounted under the gyroscope 34 for covering the gyroscope 34. A gyroscope mounting cavity is formed between the gyroscope mounting cover 31 and the gyroscope mounting plate 60, and the gyroscope is disposed in the gyroscope mounting cavity, thereby well protecting the gyroscope to avoid external interference. In the embodiment, the driving mechanism 30 is rotationally mounted to the main framework 50 through the connecting shaft 53, and the gyroscope is mounted in the driving mechanism 30. When an inclination angle of the driving mechanism 30 relative to the main framework 50 increases, the self-balancing scooter accelerates forwards or accelerates backwards, and when the inclination angle of the driving mechanism 30 relative to the main framework 50 decreases, the self-balancing scooter decelerates forwards or decelerates backwards. And the change of the inclination angle of the driving mechanism 30 relative to the main framework 50 also controls the gyroscopes mounted in the two driving mechanisms 30 to control the direction of the self-balancing scooter.

As shown in FIGS. 7-8, the self-balancing scooter further includes a light bar 32 and a light bar cover 33, the driving mechanism 30 is configured with a light bar mounting region 63, and the light bar 32 and the light bar cover 33 are both mounted to the light bar mounting region 63, thereby providing a good lighting effect for the self-balancing scooter, and further improving the market competitiveness of the self-balancing scooter.

As shown in FIG. 10, the self-balancing scooter further includes an infrared sensor switch 26. The infrared sensor switch 26 includes an infrared emitter 261 and an infrared receiver 262, and the infrared receiver 262 is in communication with the infrared emitter 261. The infrared emitter 261 and the infrared receiver 262 are both mounted to the foot pedal 20. When the user stands on the foot pedal, the feet of the user isolate the communication between the infrared emitter 261 and the infrared receiver 262, the self-balancing scooter starts running. When the user leaves the self-balancing scooter, the infrared receiver 262 can receive a signal sent by the infrared emitter 261, the self-balancing scooter stops running. In addition, the infrared sensor switch 26 may also be replaced by a photoelectric switch and a silicone elastic mechanism, the photoelectric switch and the silicone elastic mechanism are both mounted to the driving mechanism. When the user stands on the foot pedal, the photoelectric switch contacts the silicone elastic mechanism, thereby starting the self-balancing scooter. When the feet leave the self-balancing scooter, the photoelectric switch and the silicone elastic mechanism are separated, and thus the self-balancing scooter stops running. In the embodiment, the starting signal is sensitive, and the accident caused by the signal problem does not occur.

As shown in FIG. 10, the foot pedal 20 further includes a liquid crystal display 23 and two silicone pads 22a and 22b. The two silicone pads 22a and 22b are respectively mounted to the left foot pedal 21a and the right foot pedal 21b, and the liquid crystal display 23 is mounted to the storage box cover 24. The self-balancing scooter of the disclosure is more intelligent than the prior self-balancing scooter, and the anti-slip capability of the foot pedal 20 is increased, thereby further improving the market competitiveness of the self-balancing scooter.

The above embodiments are only the preferred embodiments of the present invention, and do not limit the scope of the present invention. A person skilled in the art may make various other corresponding changes and deformations based on the described technical solutions and concepts. And all such changes and deformations shall also fall within the scope of the present invention.

What is claimed is:

1. A self-balancing scooter, comprising:
a scooter body comprising an integrated main framework with two opposite ends and wheels mounted to the two ends of the main framework respectively;
a driving mechanism mounted on the main framework;
a foot pedal mounted on the driving mechanism; and
a connecting shaft with a first end and a second end opposite to the first end;
wherein the first end of the connecting shaft is fixedly connected to the main framework, and the second end of the connecting shaft is connected to the driving mechanism such that the driving mechanism and the foot pedal are pivotable relative to the main framework; the driving mechanism drives the wheels to rotate.

2. The self-balancing scooter of claim 1, further comprising another driving mechanism, wherein each of the driving mechanisms is connected to the main framework through two connecting shafts.

3. The self-balancing scooter of claim 2, wherein the self-balancing scooter further comprises a bearing member, a number of the bearing member is corresponding to a number of the connecting shaft, and the connecting shaft is connected to the main framework through the bearing member.

4. The self-balancing scooter of claim 2, wherein the connecting shaft is configured with a first through hole, the driving mechanism is configured with a screw hole, and a position of the screw hole is corresponding to a position of the first through hole.

5. The self-balancing scooter of claim 2, wherein the self-balancing scooter further comprises an elastic member connected between the driving mechanism and the main framework.

6. The self-balancing scooter of claim 5, wherein the elastic member comprises a coil spring and a spring cap mounted to the driving mechanism, the coil spring comprises a first end and a second end, the first end of the coil spring is mounted to the main framework, and the second end of the coil spring is connected to the spring cap.

7. The self-balancing scooter of claim 2, wherein the foot pedal comprises a left foot pedal and a right foot pedal, and the left foot pedal is mounted on the driving mechanism and the right foot pedal is mounted on the another driving mechanism.

8. The self-balancing scooter of claim 1, wherein the scooter body is configured with a battery and a control panel, and the battery and the control panel are both electrically connected to the driving mechanism.

9. The self-balancing scooter of claim 8, wherein the drive mechanism comprises a gyroscope and a gyroscope mounting plate, and the gyroscope is mounted to the gyroscope mounting plate and connected to the control panel.

10. The self-balancing scooter of claim 1, wherein the scooter body further comprises a motor clamp, and the wheel comprises a motor body and a first rotating shaft extending from the motor body, and the first rotating shaft is connected to the main framework through the motor clamp.

11. The self-balancing scooter of claim 7, wherein the self-balancing scooter further comprises an infrared sensor switch, and the infrared sensor switch is mounted to the foot pedal.

12. The self-balancing scooter of claim 11, wherein the infrared sensor switch comprises a first infrared sensor switch mounted to the left foot pedal and a second infrared sensor mounted to the right foot pedal.

13. The self-balancing scooter of claim 12, wherein the infrared sensor switch comprises an infrared emitter and an infrared receiver; the infrared emitter of the first infrared sensor switch is mounted at a side of the left foot pedal, and the infrared receiver of the first infrared sensor switch is mounted at an opposite side of the left foot pedal and facing the infrared emitter of the first infrared sensor switch; the infrared emitter of the second infrared sensor switch is mounted at a side of the right foot pedal, and the infrared receiver of the second infrared sensor switch is mounted at an opposite side of the right foot pedal and facing the infrared emitter of the second infrared sensor switch.

14. The self-balancing scooter of claim 1, wherein the self-balancing scooter further comprises a storage box, an upper cover, a rotating shaft, and a storage box cover; the upper cover is rotationally mounted on the storage box via the rotating shaft, and the storage box cover is mounted on the upper cover.

15. The self-balancing scooter of claim 14, wherein the self-balancing scooter further comprises a liquid crystal display, and the liquid crystal display is mounted to the storage box cover.

16. The self-balancing scooter of claim 14, wherein the self-balancing scooter further comprises a storage box switch mounted on the upper cover and configured to open or close the storage box cover.

17. The self-balancing scooter of claim 1, wherein the self-balancing scooter further comprises a bearing member and a bearing fixing member; the first end of the connecting shaft is mounted in the bearing member, and the bearing member is mounted on the main framework through the bearing fixing member.
